(19) United States
(12) Patent Application Publication
(10) Pub. No.: US 2016/0087321 A1
(43) Pub. Date: Mar. 24, 2016

(54) Separator-Cathode Current Collector Element

(71) Applicant: Robert Bosch GmbH, Stuttgart (DE)

(72) Inventors: Thomas Wöhrle, München (DE); Felix Eberle, Kyoto (JP); Vikram Anil Godbole, Stuttgart (DE)

(21) Appl. No.: 14/861,215

(22) Filed: Sep. 22, 2015

(30) Foreign Application Priority Data
Sep. 22, 2014 (DE) 10 2014 218 993.4

(51) Int. Cl. H01M 12/08; H01M 4/88; H01M 2/16; H01M 4/86; H01M 8/10

(52) U.S. Cl. CPC H01M 12/08; H01M 4/8626; H01M 8/1004; H01M 2/1673; H01M 4/8807; H01M 4/881; H01M 4/8817; H01M 4/8846; H01M 2004/8689

(57) ABSTRACT

A separator-cathode current collector element for a metal-oxygen cell, in particular for a lithium-oxygen cell, includes a porous cathode current collector and a separator coating disposed on one side of the current collector in order to improve performance and lifespan of the cell. A process for producing a separator-cathode current collector element includes coating one side of the porous cathode current collector with the separator material. A cell and a battery can be equipped with the separator-cathode current collector element.

This application claims priority under 35 U.S.C. §119 to patent application no. DE 10 2014 218 993.4, filed on Sep. 22, 2014 in Germany, the disclosure of which is incorporated herein by reference in its entirety.

This disclosure relates to a separator-cathode current collector element for a metal-oxygen cell, in particular for a lithium-oxygen cell, a process for producing such a separator-cathode current collector element and also a cell and battery equipped therewith.

### BACKGROUND

Lithium ion cells and batteries are used in many products which extend from cellular telephones through to electric vehicles and generally have a transition metal oxide-based cathode and a graphite-based anode. However, the specific energy density of such lithium ion cells is relatively low and in practice is generally about 200 Wh/kg.

In contrast, specific energy densities of over 1300 Wh/kg can theoretically be achieved by lithium-oxygen cells and batteries, which are also referred to as lithium-air cells or batteries. In the document U.S. Pat. No. 5,510,209 A, Abraham et al. describe one of the first lithium-air cells.

Lithium-oxygen cells usually have a lithium foil as anode, which is also referred to as negative electrode and which can be applied to a copper foil serving as anode current collector. As cathode, which is also referred to as positive electrode, lithium-oxygen cells usually have a layer which is composed of a mixture of conductive carbon black and/or graphite, a catalyst, for example manganese dioxide (MnO₂), and a binder and can be applied, for example, to an aluminum foil or nickel foil serving as cathode current collector. As separator in lithium-oxygen cells, use is usually made of a self-supporting, gastight membrane which, in order to ensure lithium ion transport necessary for the electrochemical reaction of the lithium-oxygen cell and to avoid an internal short circuit between cathode and anode, is made of a material which conducts lithium ions and is electrically insulating.

During discharge of a lithium-air battery, lithium ions migrate from the lithium anode through the separator and react with oxygen (O₂) on the cathode side, with oxygen (O₂) being reduced to peroxide (O₂²⁻) and oxide (O²⁻) and solid, electrically nonconductive lithium peroxide (Li₂O₂) and lithium oxide (Li₂O) being formed.

During charging, lithium peroxide (Li₂O₂) and lithium oxide (Li₂O) are converted by means of the catalyst back into oxygen (O₂) and lithium ions which migrate back to the anode.

At present, self-supporting solid-state separators having a comparatively large layer thickness, in particular >150 μm, are usually employed in lithium-oxygen cells. However, the large layer thickness is associated with a high internal resistance of the cell and thus also with significantly higher overvoltages during charging and discharging and also an increased energy consumption during charging, of which only part can be recovered during discharging.

In addition, the mass production of defect-free, self-supporting solid-state separators is difficult. Although self-supporting solid-state separators can be produced, for example, by means of laser deposition (pulsed laser deposition), physical vapor deposition (PVD) or chemical vapor deposition (CVD), these processes are normally batch processes which have only poor suitability for mass production.

The document WO 00/36677 A1 describes an air electrode for electrochemical cells, which has a carbon matrix with an oxygen reduction catalyst and a fluorinated polymer binder as active layer.

The document WO 01/71830 A2 describes a production process for a cathode arrangement for a metal-air battery.

The document US 2012/0100440 A1 describes a process for producing lithium-air batteries.

### SUMMARY

The present disclosure provides a separator-cathode current collector element for a metal-oxygen cell, in which one side of a porous cathode current collector is provided or coated with a separator coating. The separator-cathode current collector element according to the disclosure can, in particular, be produced by coating one side of a porous cathode current collector with a separator material.

The disclosure therefore further provides a process for producing a separator-cathode current collector element for a metal-oxygen cell, wherein one side, in particular a main face, of a porous cathode current collector is coated with a separator material.

For the purposes of the present disclosure, a metal-oxygen cell is, in particular, an electrochemical cell in which metal ions, for example lithium ions or magnesium ions or zinc ions, and oxygen participate in the electrochemical reaction therein. For example, the metal-oxygen cell can be a lithium-oxygen cell, which may also be referred to as lithium-air cell, or a magnesium-oxygen cell, which may also be referred to as magnesium-air cell, or a zinc-oxygen cell, which may also be referred to as zinc-air cell. In particular, the metal-oxygen cell can be a lithium-oxygen cell.

For the purposes of the present disclosure, a cathode current collector is, in particular, a current collector of a cathode, for example of an oxygen electrode.

For the purposes of the present disclosure, a separator coating is, in particular, a gastight coating composed of a material which conducts metal ions, for example lithium ions or magnesium ions or zinc ions, and in particular is electrically insulating.

For the purposes of the present disclosure, a separator material is, in particular, a material which is able to form a separator coating.

The porous cathode current collector advantageously serves as support matrix which can be coated, in particular directly, with the separator coating or the separator material and in this way makes it possible to produce a separator in the form of a thin, in particular defect-free, film having a small layer thickness, for example of only from 3 μm to 4 μm. In particular, such thin, in particular defect-free, films composed of inorganic materials such as solid-state metal ion conductors, for example solid-state lithium ion conductors, can advantageously be produced.

A very thin separator can advantageously reduce the internal resistance and also overvoltages during charging and discharging of a cell equipped therewith and thus improve the performance thereof. In particular, the charging efficiency of a cell equipped therewith can be improved in this way and, for example, the energy consumption required during charging can be reduced.

In addition, the separator-cathode current collector element can advantageously have a greater mechanical stability or a lower fragility than a self-supporting separator and can therefore be easier to handle.

Furthermore, firm bonding of the separator to the cathode current collector can advantageously be achieved by coating, in particular direct coating. Interfacial resistances between separator and cathode can be reduced in this way and the internal cell resistance can thus be reduced further and the C-rate capability, the cycling stability and the life of a cell equipped therewith can also be improved, which is particularly advantageous for high-energy applications, for example for electric vehicles or hybrid vehicles or stationary power storage facilities.

In addition, a coating process, in particular a direct coating process, can advantageously be carried out simpler and more cheaply compared to production processes for producing self-supporting separators. Coating processes, in particular direct coating processes, can also advantageously be carried out as continuous (in-line) processes, which is particularly advantageous for mass production.

The side of the cathode current collector which is provided with the separator coating or the separator material can, in particular, be a main face of the cathode current collector.

The cathode current collector can, for example, be in the form of a (pseudo)two-dimensional network, for example in the form of a woven fabric, or in the form of a three-dimensional foam or felt.

In one embodiment, the cathode current collector is in the form of a felt, woven fabric or foam. Such materials can advantageously not only be used as sheets or plates, but in particular also from a roll, which advantageously makes a continuous production process possible.

In a further, additional or alternative embodiment, the cathode current collector is made of carbon, aluminum and/or nickel. These materials can advantageously have a sufficient electrical conductivity and can be procured comparatively cheaply. Aluminum and nickel have a particularly high electrical conductivity. Carbon can advantageously have a certain ion conductivity, in particular lithium ion conductivity, which makes it possible to reduce or omit ion-conducting additives in the cathode material and in this way increase the specific energy density. In addition, these materials can advantageously be processed easily to give woven fabrics, foams or felts.

For example, the cathode current collector can be a carbon felt or an aluminum mesh or a nickel mesh or an aluminum foam or a nickel foam. For example, the cathode current collector can be a carbon felt or a nickel mesh or a nickel foam.

The separator coating can be composed of an inorganic material or an organic material, for example a polymer. For example, the separator coating or the separator material can comprise or consist of at least one, for example inorganic and/or polymeric, metal ion-conducting solid electrolyte. In particular, the separator coating or the separator material can comprise or consist of at least one, for example inorganic and/or polymeric, lithium ion-conducting or magnesium ion-conducting or zinc ion-conducting solid electrolyte.

Gastight coatings which serve as oxygen, carbon dioxide and moisture barriers and can prevent transition of oxygen, carbon dioxide and moisture from the cathode side to the anode side and in this way prevent reaction of these materials with the anode can advantageously be made of solid electrolytes. In addition, coatings composed of solid electrolytes can suppress or even prevent dentrite growth, for example of lithium dentrites, from the anode to the cathode and the internal short circuits associated therewith. Furthermore, coatings formed by solid electrolytes can prevent electrolyte transfer between the anode side and the cathode side. In this way, decomposition reactions which could otherwise occur, for example, at the anode, for example by reaction with metallic lithium, can advantageously be avoided.

In a further embodiment, the separator coating or the separator material comprises at least one inorganic solid-state lithium ion conductor and/or at least one polymer electrolyte which conducts lithium ions or is capable of conducting lithium ions.

For example, the at least one polymer electrolyte which conducts lithium ions or is capable of conducting lithium ions can comprise or be a polymer electrolyte based on polyethylene oxide. For example, the at least one polymer electrolyte which conducts lithium ions or is capable of conducting lithium ions can comprise or be a Nafion polymer electrolyte and/or a polymer electrolyte composed of polyethylene oxide (PEO) and at least one lithium electrolyte salt, for example lithium perchlorate (LiClO₄) and/or lithium bis(trifluoromethane)sulfonimide (LiN(CF₃SO₂)₂), for example PEO/LiClO₄ and/or (LiN(CF₃SO₂)₂)/(CH₂CH₂O)ₙ, for example with n=8.

However, the separator coating can in particular be composed of an inorganic material. Particular dentrite-resistant coatings can advantageously be made of inorganic materials. The coating, in particular direct coating, of the cathode current collector advantageously makes it possible to obtain thin, film-like coatings which are composed of inorganic materials and can advantageously have a smaller layer thickness than conventional, self-supporting membranes composed of inorganic materials.

In a specific embodiment, the separator coating or the separator material comprises at least one inorganic solid-state lithium ion conductor.

For example, the at least one inorganic solid-state lithium ion conductor can comprise or be a vitreous and/or ceramic, phosphate-based and/or germanate-based and/or sulfidic and/or phosphidic lithium ion conductor and/or a lithium-lanthanum titanate and/or a lithium-lanthanum zirconate and/or lithium nitride (Li₃N) and/or an Li-β-aluminum oxide and/or a mixture thereof.

The at least one inorganic solid-state lithium ion conductor can, for example, comprise or be a lithium ion conductor of the NASICON type, in particular one which can be derived from or is based on the general chemical formula: AB₂^{IV}(PO₄)₃, for example with A=Li and/or Na and B=Ti and/or Zr and/or Ge and/or Hf. Here, A and/or B and/or P can optionally be replaced by other metals, for example Al. For example, the at least one inorganic solid-state lithium ion conductor can comprise or be lithium-aluminum-titanium phosphate (LATP) and/or Li₁₊ₐAlₐGe₂₋ₐ(PO₄)₃.

As an alternative or in addition, the at least one inorganic solid-state lithium ion conductor can, for example, comprise or be a lithium superionic conductor (LISICON), in particular based on or derivable from the general chemical formula: Li_{16-2q}Q_{q}(XO₄)₄, for example where Q is a divalent cation, for example Zn²⁺ and/or Mg²⁺, and X is a tetravalent cation, for example Ge⁴⁺ and/or Si⁴⁺, and 0<q<4. For example, the at least one inorganic solid-state lithium ion conductor can comprise or be a LISICON, in particular based on or derivable from the general chemical formula: Li₂₊₂ₓZn₁₋ₓGeO₄ where 0≦x≦1. For example, the at least one inorganic solid-state lithium ion conductor can comprise or be Li₁₄Zn(GeO₄)₄.

As an alternative or in addition, the at least one inorganic solid-state lithium ion conductor can comprise or be, for example, a thio-LISICON, in particular based on or derivable from the general chemical formula: Li_{4-y}M_{1-z}M′_{z}S₄ where M=Si and/or Ge and/or P and M′=P and/or Al and/or Zn and/or Ga and/or Sb and/or Sn and/or Ge. For example, the at least one inorganic solid-state lithium ion conductor can comprise or be Li_{3.25}Ge_{0.25}P_{0.75}S₄ and/or Li₄GeS₄ and/or Li₁₀GeP₂S₁₂ and/or Li₁₀SnP₂S₁₂ and/or Li₇P₃S₁₁.

As an alternative or in addition, the at least one inorganic solid-state lithium ion conductor can comprise or be, for example, a glass-ceramic such as Li₂S—SiS₂—Li₃PO₄ and/or Li₂S—P₂S₅, and/or lithium-phosphorus oxynitride (LiPON) and/or a lithium-lanthanum titanate, for example Li_{3b}La_{(2/3)-b}TiO₃, 0<b<0.16, for example La_{0.5}Li_{0.5}TiO₃, and/or a lithium-lanthanum zirconate, for example Li₇La₃Zr₂O₁₂, and/or lithium nitride (Li₃N), for example undoped and/or doped lithium nitride, and/or an Li-β-aluminum oxide.

The coating of the cathode current collector with the separator material can, in particular, be carried out by means of direct coating.

In a further embodiment, the coating of the cathode current collector with separator material is carried out by a liquid coating process. The coating of the cathode current collector with cathode material can, for example, be carried out by spray coating, for example by means of a spray gun (spray painting), and/or by blade coating, in particular by means of a doctor blade (doctor blading), and/or by slot die coating, in particular by means of a slot die, and/or by dip coating. Here, the coating of the cathode current collector with separator material can, in particular, be carried out by means of a suspension containing separator material. The suspension can comprise at least one solvent in addition to the separator material and be produced, for example by dispersing the separator material in the at least one solvent. The cathode current collector can then be coated with this suspension. For example, the separator material can be applied in the form of a slurry or dye, in particular directly, to the cathode current collector. In this way, coatings, in particular, defect-free coatings, can advantageously be produced in a simple manner which is suitable for mass production.

After coating with separator material, which can, for example, be carried out in a process step a), the cathode current collector which has been coated with separator material can be dried and/or sintered, for example in a process step s).

In a further embodiment, the coating comprised of separator material is therefore dried and/or sintered. In particular, the coating comprising of separator material can be dried and/or sintered before coating with cathode material as explained below. In this way, a cathode current collector having a precoated separator coating on one side can be produced advantageously.

If the separator material comprises a polymer electrolyte, the coating composed of separator material is preferably merely dried and sintering is dispensed with.

However, if the separator material comprises an inorganic solid-state lithium ion conductor, the coating composed of separator material is preferably sintered. For example, the coating composed of separator material can be (firstly) dried and (then) sintered. A sintered separator coating, in particular, can be formed by sintering. The separator coating can therefore be, in particular, a sintered separator coating. Any binders and/or other organic components present in the separator material can be burnt out by means of the sintering. The separator coating of the separator-cathode current collector element can therefore be, in particular, binder-free.

The sintering of the coating composed of separator material can, in particular, be effected by heating to a temperature in the temperature range from ≧800° C. to ≦1200° C. At such high temperatures, inorganic particles, for example in the micron range and/or nanometer range, for example composed of lithium-aluminum-titanium phosphate (LATP) or another inorganic solid-state lithium ion conductor, can advantageously be sintered together. In this way, a defect-free, thin, in particular electrically insulating, separator coating can again advantageously be formed on one side of the cathode current collector.

The separator coating or the dried and/or sintered, in particular sintered, coating composed of separator material can, in particular, have an average layer thickness in the range from ≧3 μm to ≦100 μm, by way of example from ≧3 μm to ≦20 μm, for example from ≧3 μm to ≦15 μm.

After drying and/or sintering, for example in process step s), the cathode current collector can then be coated on the other side with a cathode material, for example in a process step b). The separator-cathode current collector element can in this way advantageously also serve as separator-cathode current collector-cathode material element.

In a further embodiment, another side or the other side of the cathode current collector is therefore coated or provided with a cathode material. The other side of the cathode current collector can be, in particular, a side, in particular main face, of the cathode current collector which is opposite the side coated with the separator material or the side provided with the separator coating.

When coating with cathode material is carried out, cathode material can, in particular, be introduced into the pores of the cathode current collector or penetrate into these pores. The pores on the other side of the cathode current collector can therefore be, in particular at least partly, infiltrated or filled with cathode material. Here, the surface of the pores of the cathode current collector can be provided or coated, in particular (at least) partly, with a cathode material coating.

In a further embodiment, the cathode material comprises at least one catalyst. The at least one catalyst can, for example, be a cathode catalyst and in particular be suitable for catalyzing oxidation of oxygen ions to elemental oxygen and/or for reducing elemental oxygen to oxygen ions. For example, the at least one catalyst can comprise or be manganese dioxide, for example α-manganese dioxide (α-MnO₂) and/or electrolytic manganese dioxide, and/or cobalt(II,III) oxide (Co₃O₄) and/or copper(II) oxide (CuO) and/or nickel(II) oxide (NiO) and/or α-iron(III) oxide (α-Fe₂O₃) and/or gold.

In a further embodiment, the cathode material further comprises at least one binder. For example, the binder can comprise or be polyvinylidene fluoride (PVDF) and/or polyvinylidene fluoride-hexafluoropropylene (PVDF-HFP) and/or polyethylene oxide (PEO) and/or polytetrafluoroethylene (PTFE) and/or Nafion and/or cellulose and/or styrene-butadiene rubber (SBR).

The cathode material can optionally further comprise at least one conductive additive. In particular, the at least one conductive additive can comprise carbon, by way of example conductive carbon, for example in the form of carbon particles. For example, the at least one conductive additive can comprise or be carbon black and/or graphite. The electrical and/or ionic contacting on the cathode side may be able to be improved by the at least one conductive additive. Since the cathode current collector itself can be made of an electrically conductive and/or ion-conducting material, by way of example carbon, for example in the form of a carbon felt, the addition of conductive additives to the cathode material may be able to be dispensed with and the specific energy density may be improved further in this way.

In a further embodiment, the coating of the cathode current collector with cathode material is carried out by a liquid coating process. The coating of the cathode current collector with cathode material can, for example, be carried out by spray coating, for example by means of a spray gun (spray painting), and/or by blade coating, in particular by means of a doctor blade (doctor blading), and/or by slot die coating, in particular by means of a slot die, and/or by dip coating. Here, the coating of the cathode current collector with cathode material can, in particular, be carried out by means of a suspension containing cathode material. The suspension can comprise at least one solvent in addition to the cathode material and be produced, for example, by dispersing the cathode material in the at least one solvent. The cathode current collector can then be coated with this suspension. For example, the cathode material can be applied in the form of a slurry or dye, in particular directly, to the cathode current collector.

After coating with cathode material, for example in process step b), the cathode current collector coated with cathode material can be dried, for example in a process step t). Sintering may be able to be dispensed with here. The cathode material of the separator-cathode current collector-(cathode material) element can therefore contain binder.

The resulting separator-cathode current collector-cathode material element can then advantageously be assembled directly and in a simple manner to make a metal-oxygen cell or battery.

As regards further technical features and advantages of the separator-cathode current collector-(cathode material) element of the disclosure and the production process of the disclosure, reference will hereby be explicitly made to the explanations in connection with the cell and battery according to the disclosure and to the figures and the description of the figures.

The disclosure further provides a metal-oxygen cell which comprises a separator-cathode current collector element or separator-cathode current collector-cathode material element according to the disclosure and/or a separator-cathode current collector element or separator-cathode current collector-cathode material element produced according to the disclosure.

Here, the cell can have, in particular, a metal anode which, for example, comprises metallic lithium or metallic magnesium or metallic zinc.

For example, the metal-oxygen cell can be a lithium-oxygen cell or a magnesium-oxygen cell or a zinc-oxygen cell.

In particular, the metal-oxygen cell can be a lithium-oxygen cell. Here, the cell can have, in particular, a lithium anode, for example composed of metallic lithium or a lithium alloy. As anode, it is possible to use, for example, a lithium foil.

Furthermore, the cell can have an anode current collector, for example composed of copper. As anode current collector, it is possible to use, for example, a copper foil.

In addition, the cell can comprise at least one, in particular non-aqueous, liquid electrolyte. For example, the anode and/or the cathode, in particular the side of the porous cathode current collector provided with cathode material, can be wetted and/or impregnated with the at least one liquid electrolyte. In this case, the anode and the cathode can be wetted or impregnated with different electrolytes.

The disclosure further relates to a metal-oxygen battery, in particular a lithium-oxygen battery, which comprises at least two cells according to the disclosure, in particular lithium-oxygen cells. As regards further technical features and advantages of the cell and battery of the disclosure, reference is hereby explicitly made to what has been said in connection with the separator-cathode current collector-(cathode material) element of the disclosure and the production process of the disclosure and also to the figures and the description of the figures.

### BRIEF DESCRIPTION OF THE DRAWINGS

Further advantages and advantageous embodiments of the subject matter of the disclosure are illustrated by the drawings and explained in the following description. It should be noted that the drawings merely have a descriptive character and are not intended to restrict the disclosure in any way.

In the Drawings:

FIG. 1 shows a schematic cross section to illustrate an embodiment of the process of the disclosure for producing a separator-cathode current collector-(cathode material) element for a lithium-oxygen cell; and

FIG. 2 shows a schematic cross section through a lithium-oxygen cell which is equipped with an embodiment of a separator-cathode current collector-(cathode material) element according to the disclosure.

### DETAILED DESCRIPTION

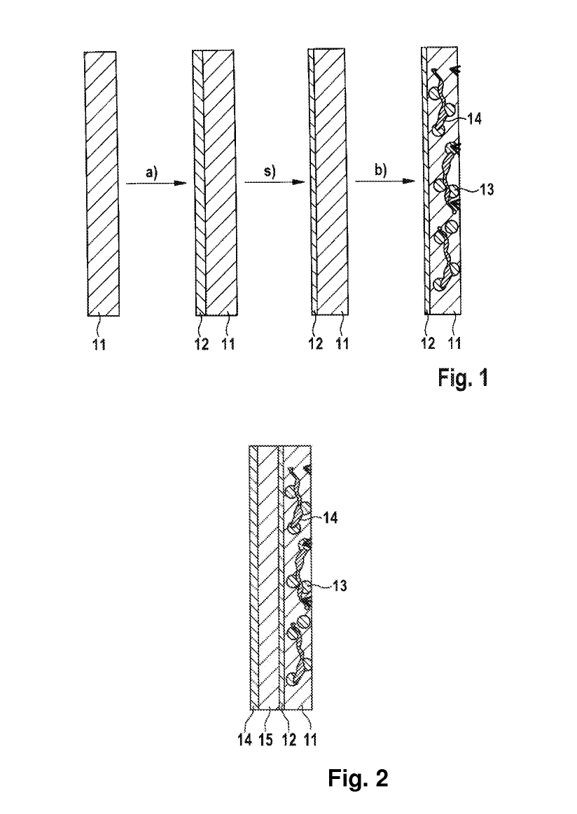

It can be seen from FIG. 1 that a porous cathode current collector 11 is firstly provided in the form of a felt, woven fabric or foam composed of carbon, aluminum and/or nickel. For example, the cathode current collector 11 can be a carbon felt or a nickel mesh or a nickel foam.

Furthermore, FIG. 1 shows that one side, in particular a main face, of the cathode current collector 11 is coated with a separator material 12, for example in a process step a).

Here, coating can be effected, for example, by means of a suspension containing separator material 12. The suspension can, for example, comprise at least one solvent in which the separator material 12 is dispersed. The separator material 12 can, for example, comprise an inorganic solid-state lithium ion conductor and/or a polymer electrolyte which conducts or is capable of conducting lithium ions. FIG. 1 indicates that, in particular, a main face of the cathode current collector 11 is coated with the separator material 12.

FIG. 1 shows that the cathode current collector 11 which has been coated with the separator material 12 is dried and/or sintered, for example in a process step s). FIG. 1 shows that this can reduce the layer thickness of the coating of separator material so that the resulting separator coating 12 can have a smaller average layer thickness, by way of example in the range from ≧3 μm to ≦100 μm, for example from ≧3 μm to ≦20 μm.

FIG. 1 also shows that another side of the cathode current collector 11 is then coated with a cathode material 13, 14, for example in a process step b). FIG. 1 indicates that the other side coated with the cathode material 13, 14 of the cathode current collector 11 which is opposite the side of the cathode current collector 11 coated with the separator material 12 and in particular represents a further main face of the cathode current collector 11. FIG. 1 illustrates that cathode material 13, 14 penetrates into the pores of the cathode current collector 11 and partly fills these or coats the surface thereof during the coating operation.

The coating with cathode material 13, 14 can also be effected by means of a suspension. Here, the suspension can, for example, comprise at least one solvent in which the cathode material 13, 14 is dispersed. The cathode material 13, 14 can comprise, in particular, at least one catalyst 13 for catalyzing oxidation of oxygen ions to elemental oxygen and/or for reducing elemental oxygen to oxygen ions and also at least one binder 14.

FIG. 2 shows a lithium-oxygen cell which is equipped with a separator-cathode current collector-(cathode material) element 11, 12, 13, 14. Here, the separator-cathode current collector-(cathode material) element 11, 12, 13, 14 comprises a porous cathode current collector 11, for example in the form of a felt, woven fabric or foam composed of carbon, aluminum and/or nickel, of which cathode current collector 11 one side is provided with a separator coating 12 and another side opposite the side provided with the separator coating 12 is provided with a cathode material 13, 14.

FIG. 2 shows that the cell additionally has a metal anode 15, for example composed of metallic lithium or a lithium alloy, applied to an anode current collector 14. FIG. 2 shows that the separator coating 12 of the separator-cathode current collector-(cathode material) element 11, 12, 13, 14 is arranged in contact with the metal anode 15.

What is claimed is:

1. A process of producing a separator-cathode current collector element for a metal-oxygen cell, comprising:
coating one side of a porous cathode current collector with a separator material.

2. The process according to claim 1, further comprising:
coating an other side of the current collector with a cathode material such that the cathode material penetrates into pores of the current collector.

3. The process according to claim 2, wherein the coating of the other side of the current collector with the cathode material is performed via a suspension that includes cathode material.

4. The process according to claim 2, further comprising:
prior to the coating of the other side of the current collector with the cathode material, performing at least one of:
drying the coating of separator material; and
sintering the coating of separator material.

5. The process according to claim 4, wherein the sintering of the coating of separator material includes heating the coating of separator material to a temperature that is equal to or greater than 800° C. and less than or equal to 1,200° C.

6. The process according to claim 1, wherein the coating of the one side of the current collector with the separator material is performed via a suspension that includes separator material.

7. The process according to claim 1, wherein the current collector is at least one of:
(i) configured as a felt, woven fabric, or foam; and
(ii) formed from at least one of carbon, aluminum, and nickel.

8. The process according to claim 1, wherein the separator material includes at least one of:
at least one inorganic solid-state lithium ion conductor; and
at least one polymer electrolyte which either conducts lithium ions or is configured to conduct lithium ions.

9. A separator-cathode current collector element for a metal-oxygen cell, comprising:
a porous cathode current collector; and
a separator coating disposed on one side of the current collector.

10. The current collector element according to claim 9, wherein the current collector is configured as a felt, a woven fabric, or foam.

11. The current collector element according to claim 9, wherein the current collector is formed from at least one of carbon, aluminum, and nickel.

12. The current collector element according to claim 9, further comprising:
a cathode material positioned at an other side of the current collector,
wherein the cathode material includes at least one catalyst configured to at least one of:
catalyze oxidation of oxygen ions to elemental oxygen; and
reduce elemental oxygen to oxygen ions.

13. The current collector element according to claim 9, wherein the separator coating includes at least one of (i) at least one inorganic solid-state lithium ion conductor, and (ii) at least one polymer electrolyte that either conducts lithium ions or is configured to conduct lithium ions.

14. The current collector element according to claim 9, wherein the current collector element is configured for a lithium-oxygen cell.

15. The current collector element according to claim 9, wherein the current collector element is produced via the process according to claim 1.

16. A lithium-metal cell, comprising:
a separator-cathode current collector element that includes:
a porous cathode current collector; and
a separator coating disposed on one side of the current collector;
wherein the current collector element is produced by coating one side of a porous cathode current collector with a separator material.
